(19) United States
(12) Patent Application Publication
(10) Pub. No.: US 2009/0276816 A1
(43) Pub. Date: Nov. 5, 2009

(54) System And Method For Obtaining And Distributing Video

(76) Inventor: Anh Hao Tran, San Jose, CA (US)

Correspondence Address: SHELDON MAK ROSE & ANDERSON PC, 100 Corson Street, Third Floor, PASADENA, CA, 91103-3842, US

(21) Appl. No.: 12/115,477

(22) Filed: May 5, 2008

(51) Int. Cl. H04N 7/173

(52) U.S. Cl. 725/87

(57) ABSTRACT

A method for obtaining and distributing video having the steps of: receiving a request for a video recording device from a user; sending a video recording device to the user; receiving the video recording device from the user, the video recording device having stored thereon a video about a subject; collecting information about the subject of the video; and transferring the video from the video recording device and the collected information about the subject to a database accessible via a global computer network.

### BACKGROUND

In 2007, over a trillion dollars changed hands through the sales of homes in the United States. Home buyers in the United States are turning to the Internet in their search for a new home. Several websites exist for helping buyers research homes. However, typical real estate websites offer only low resolution images, virtual tours, and basic listing information.

This incomplete information necessitates that buyers visit many homes in person, many times finding immediately that the house is not to their liking and was not worth visiting. It would be very desirable to provide videos of the properties for sale.

However, several factors limit the use of video to sell real estate. Many sellers and brokers do not have a video camera or know how to operate a video camera to produce helpful videos. Additionally, many sellers and brokers do not know how to upload videos to the Internet.

There is a need for a method and system for obtaining and distributing property information that solves the shortcomings of the prior art.

### SUMMARY

Accordingly, the present invention, according to a first embodiment, is directed to a method for acquiring and distributing video comprising the steps of: receiving a request for a video recording device from a user; sending a video recording device to the user; receiving the video recording device from the user, the video recording device having stored thereon a video about a subject; collecting information about the subject of the video; and transferring the video from the video recording device and the collected information about the subject to a database accessible via a global computer network.

The request for the video recording device can be made by the user via a telephone, electronic mail, text messaging or regular mail. Additionally, the user may request the video recording device via a website.

Information about the subject of the video may be received from the user, such as by telephone, electronic mail, text messaging, or regular mail. Additionally, information about the subject of the video may be collected by accessing at least one database over a global computer network; and retrieving information corresponding to subject of the video.

Optionally, the video recording device sent to the user has a global positioning system therein and the video further comprises global positioning system information. Once the video is received, the subject of the video is correlated to a specific geographic location. Additionally, the video may be edited to add collected information about the subject of the video.

The present invention according to a second embodiment is directed to a method for acquiring and distributing video comprising the steps of: receiving a request for a video recording device from a user; sending a video recording device to the user; receiving a video from the video recording device over a global computer network, the video being of a subject; collecting information about the subject of the video; and placing the video and the collected information in a database accessible via the global computer network. Optionally, the video recording device comprises a network adapter enabling direct connection of the video recording device to a wired network or a wireless network for transferring the video.

The present invention, according to a third embodiment, is directed to a method for acquiring and distributing video comprising the steps of: receiving a request for a video recording device from a user; sending a video recording device to the user, the video recording device having a global positioning system therein and wherein video obtained with the camera is encoded with global positioning information; receiving video from the video recording device over a global computer network, the video being of a subject and having global positioning information; collecting information about the subject of the video; and placing the video and collected information in a database accessible via a global computer network.

Optionally, both the request for the video recording device and information about the subject of the video is received from the user via a website. Information about the subject of the video can also be obtained by accessing at least one database over the global computer network and retrieving information corresponding to the global positioning information on the video. Optionally, the subject of the video is a real estate item and the information collected includes the address of the item.

### BRIEF DESCRIPTION OF THE DRAWINGS

A better understanding of the present invention will be had with reference to the accompanying drawings in which:

FIG. 1 is a flowchart of a method for obtaining and distributing video according to a first embodiment of the present invention; and

FIG. 2 is a diagram of a system for obtaining and distributing video according to a second embodiment of the present invention.

### DETAILED DESCRIPTION

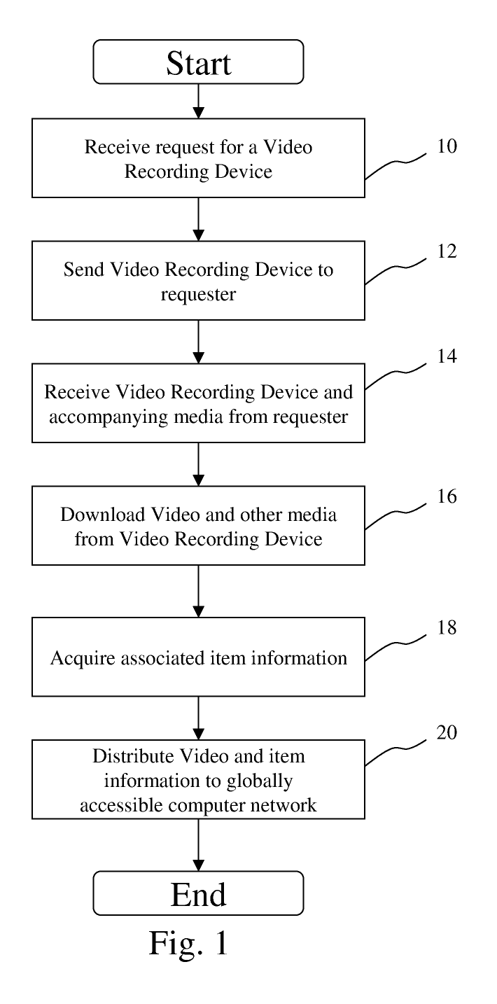

A first embodiment of the present invention will now be described with reference to FIG. 1. Sellers, agents and brokers of items for sale that would benefit from the use of video are prompted to request a video recording device. As used herein the term “video recording device” refers to any device capable of recording analog or digital video, such as a camera, camcorder, personal digital assistant or cell phone.

A requester, such as a real estate seller, agent or broker, requests a video recording device. The request can be made in several different ways. For example, the request can be made via telephone, electronic mail, text message or via regular mail. Additionally, if geographically feasible, a requester can make an in person request. A processor receives the request, box 10. The processor can be a person who speaks with the requester or reviews the text of electronic mail messages, text messages, or mail.

Additionally, the request can be made via a website that requests specific information from the requester. The specific information requested can include, for example, the mailing address and telephone number of the requester. Additionally, requester can be prompted to enter information about the item to be sold. Additionally, the website can request payment information, such as credit or debit card information as well as billing address information. The data received from a website request can be reviewed automatically by a computer at the processor.

The processor then sends a video recording device to the requester, box 20. The video recording device can be sent to the requester via regular mail, or an express courier such as United Parcel Service or Federal Express. Additionally, video recording devices can be stored at a plurality of geographically distributed facilities and a requester may be invited to pick up the video recording device at one of the facilities.

Preferably, each video recording device is encoded with a unique identifier correlated with the requester when the recording device is distributed to the requester. Preferably, the video recording device encodes all media taken with the unique identifier.

Once the video recording device has been received by the requester, the requester or another party can use the video recording device to record video of the item to be sold. For example, the requester can be a seller or broker of a real estate item and can make a video walkthrough of the real estate item. Preferably, the video recording device is capable of capturing high resolution still photos and audio, and the requester also uses the video recording device to take high resolution still photos or audio of the item.

Preferably, the video recording device sent to the requester does not require the user to provide the recording medium. Suitable video recording devices utilizing flash memory, built-in hard drives, cassettes or DVD's are known in the art. Preferably, the video recording device sent to the requester is simple to operate, requiring the user to press a single button to start and stop recording.

Once the requester, or other party, has finished recording video and any other desired media to the video recording device, the requester sends the video recording device back to the processor. The video recording device can be sent via regular mail or by using a courier. Alternatively, the requester can return the video recording device in person to a receiving location. The receiving stations to which the video recording devices are returned can be different than the locations from which the video recording devices are initially sent to requesters. For example, receiving stations can be implemented as secured kiosks in commercial locations, such as supermarkets. Additionally, the processor can pick up the video recording device from the requester.

Once the requester sends the video recording device to the processor, the processor receives the video recording device and accompanying media, box 14. Upon receipt of the video recording device, the processor downloads the video and any other media from the video recording device, box 16. This can be done using, for example, a universal serial bus (USB) or firewire connection between the video recording device and a computer.

Numerous known video recording devices are capable of plug and play use with computer operating systems such as Microsoft® Windows® for transferring video from the video recording device to the computer. Additionally, software for transferring video from a video recording device and for editing video is known in the art. For example, Microsoft® Movie Maker® can be used to transfer video from the video recording device and for editing the transferred video.

The downloaded video can be edited to improve the quality of the video for viewing. The video can also be edited to resize or compress the video for quicker access via a global computer network.

The processor acquires and collects information about the item in the video, box 18. In an embodiment of the present invention, the requester provides information about the item in the video at the time the video recording device is requested. Alternatively, the requester provides information about the item in the video when the video recording device is returned to the processor. For example, the requester may provide information about the item on the video itself, or on another medium returned with the video, such as a paper, diskette, CD, or DVD. Additionally, the requester may provide the information by telephone, text message, electronic mail, regular mail or via a website.

Information relevant to real estate items typically includes the address and property type (e.g. condominium, townhouse, single family dwelling, or multiple family dwelling. Additional relevant information may include the price, number of bedrooms, number of bathrooms, building(s) square footage, land dimensions and square footage, age of the building(s), how the building is heated, how the building is cooled, types of flooring, whether there is a pool, whether there are home owner association fees, whether there is a garage, and the number of levels. Relevant information may also include notable features of the property or the requester.

Portions of the above information can be provided by the requester or can be obtained from available public or subscription based databases. For example, relevant information can be obtained from databases maintained by government assessors, as well as national and local census databases. Additionally, relevant information can be obtained from databases maintained by private corporations such as Dataquick, OnBoard, Pictometry and multiple listing services.

Additional related information can be acquired from public or subscription based databases. For real estate items, the additional information can include, for example, map data, neighborhood data, school data and comparable listing information. The additional information can be obtained once basic item information is known.

In a preferred embodiment of the present invention, the downloaded video is edited to add additional information about the item in the video. Information such as that discussed above may be added to the video such that a viewer of the video will be able to identify the item and learn about the item's characteristics.

The video and any accompanying media is uploaded to a database accessible via a globally accessible computer network along with at least some of the acquired data about the item, box 20. The media can be uploaded to a website and accompanying database operated by the processor. Additionally, the media can be uploaded to several other globally accessible databases, such as those operated by You Tube, Google® Videos, AOL® Video, Yahoo!® Video and MSN® Soapbox.

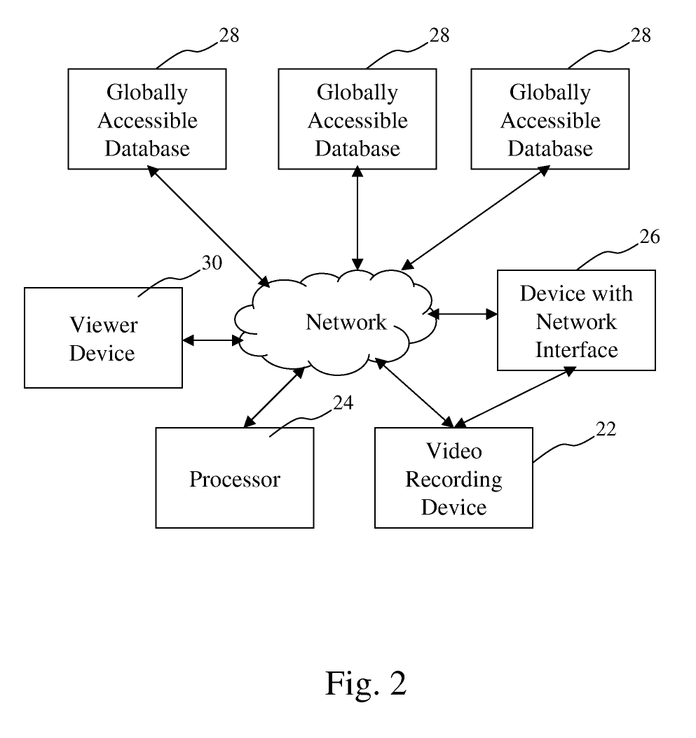

A second embodiment of the present invention will now be described with reference to FIG. 2. A requester requests and obtains a video recording device as in the first embodiment. However, in the second embodiment, video is received from the video recording device 22 without the video recording device 22 being returned to the processor 24. The video recording device 22 can then be cleared and reused.

To facilitate transfer of video from the video recording device 22 to the processor 24, the video recording device can interface with a global computer network (the Internet) or with a device 26 having a global computer network interface.

The video recording device 22 may have a built in network adapter enabling direct connection to a wired or wireless network. For example the video recording device may have an 802.11(b), 802.11(g), or 802.11(n) adapter, a Bluetooth adapter or a WWAN modem covering Enhanced Data for GSM Environment (EDGE), Evolution-Data Optimized (EV-DO), Worldwide Interoperability for Microwave Access (WiMAX), High-Speed Downlink Packet Access (HSDPA), Long Term Evolution (LTE), High-Speed OFDM Packet Access (HSOPA) and Ultra Mobile Broadband (UMB) networks. The video recording device 22 can be instructed to connect automatically to the global computer network to transfer the media from the video recording device 22 to the processor 24.

Information correlating to the video is obtained as with the first embodiment. Following transfer of video and other media from the video recording device 22, the processor 24 manipulates and distributes the video and acquired information to globally accessible databases 28 as in the first embodiment. Viewers can access the video and acquired information stored in the databases 28 using viewer devices 30, such as personal computers, cellular phones and personal digital assistants, coupled to the Internet.

Additionally, the video recording device can have a communication port for communicating with the device 26 having a global computer network interface, such as a personal computer. Software can be provided for the personal computer to cause the computer to transfer media from the video recording device 22 to the processor 26. The software preferably simplifies the process of downloading media from the video recording device by automatically detecting connection of the video recording device. The software can be provided with the video recording device or via the Internet.

A third embodiment of the present invention will now be described. The third embodiment operates the same as the first or second embodiment, except that the video recording device contains or is connected to a global positioning system (GPS). The GPS allows for location data to be appended to video or other media recorded on the video recording device. When the video or other media is obtained from the video recording device, either upon return of the video recording device to the processor, or upon receipt of the video from the video recording device, the video is immediately identified with a particular location.

Once the location of the subject of the video is known, the processor can obtain information about the subject of the video. For real estate items, the GPS information can be used to obtain most, if not all, of the property information discussed above by accessing public or subscription based databases, such as those maintained by government assessors and Dataquick.

The specification focused on the use of the present invention for facilitating the listing of real estate for sale. However, this is for illustrative purposes only and is not intended to limit the scope of the accompanying claims. One skilled in the art with reference to the present specification will recognize the applicability of the present invention to other uses, such as for selling of automobiles and businesses.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstracts and drawings, and all the steps in any method or process disclosed, may be combined in any combination except combination where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1) A method for obtaining and distributing video comprising the steps of:
a) receiving a request for a video recording device from a user;
b) sending a video recording device to the user;
c) receiving the video recording device from the user, the video recording device having stored thereon a video about a subject;
d) collecting information about the subject of the video; and
e) transferring the video from the video recording device and the collected information about the subject to a database accessible via a global computer network.

2) The method of claim 1 wherein the request for the video recording device is made by the user via at least one of the group consisting of a telephone, electronic mail, text messaging, and regular mail.

3) The method of claim 1 wherein the request for the video recording device is made by the user via a website.

4) The method of claim 1 wherein the step of collecting information about the subject of the video further comprises receiving information about the subject from the user.

5) The method of claim 4 wherein the information about the subject is received via at least one of the group consisting of telephone, electronic mail, text messaging, and regular mail.

6) The method of claim 1 wherein the step of collecting information about the subject of the video further comprises:
accessing at least one database over a global computer network; and
retrieving information corresponding to subject of the video.

7) The method of claim 1 wherein the video recording device sent to the user has a global positioning system therein and the video further comprises global positioning system information; and the method further comprises the step of correlating the subject to a specific geographic location.

8) The method of claim 1 further comprising the step of editing the video to add collected information about the subject of the video.

9) A method for obtaining and distributing video comprising the steps of:
a) receiving a request for a video recording device from a user;
b) sending a video recording device to the user;
c) receiving a video from the video recording device over a global computer network, the video being of a subject;
d) collecting information about the subject of the video; and
e) placing the video and the collected information in a database accessible via the global computer network.

10) The method for distributing video of claim 9 wherein the video recording device comprises a network adapter enabling direct connection of the video recording device to a wired network or a wireless network for transferring the video.

11) The method of claim 9 wherein the information about the subject is received from a user via at least one of the group consisting of a telephone, electronic mail, text messaging, and regular mail.

12) The method of claim 9 wherein the step of collecting information about the subject of the video further comprises:
accessing at least one database of the global computer network; and
retrieving information corresponding to the subject of the video.

13) The method of claim 9 further comprising the step of editing the video to add collected information about the subject of the video.

14) A method for obtaining and distributing video comprising the steps of:
a) receiving a request for a video recording device from a user;
b) sending a video recording device to the user, the video recording device having a global positioning system therein and wherein video obtained with the camera is encoded with global positioning information;
c) receiving video from the video recording device over a global computer network, the video being of a subject and having global positioning information;
d) collecting information about the subject of the video; and
e) placing the video and collected information in a database accessible via a global computer network.

15) The method of claim 14 wherein the request for the video recording device is made by the user via at least one of the group consisting of a telephone, electronic mail, text messaging, and regular mail.

16) The method of claim 14 wherein the step of collecting information about the subject of the video further comprises receiving information about the subject from the user.

17) The method of claim 16 wherein the information about the subject is received via at least one of the group consisting of telephone, electronic mail, text messaging, and regular mail.

18) The method of claim 16 wherein:
the request for the video recording device is received from the user via a website; and
information about the subject is received from the user via a website.

19) The method of claim 14 wherein the step of collecting information about the subject of the video further comprises:
accessing at least one database over the global computer network; and
retrieving information corresponding to the global positioning information on the video.

20) The method of claim 19 wherein:
the subject is a real estate item; and
the collected information includes the address of the item.
